(19) United States
(12) Patent Application Publication
(10) Pub. No.: US 2013/0200301 A1
(43) Pub. Date: Aug. 8, 2013

(54) MIXTURE FOR REDUCING THE FORMATION OF MAGNESIUM AMMONIUM PHOSPHATE (STRUVITE) IN CLARIFICATION PLANTS

(71) Applicants: Peter Cornel, Oberursel (DE); Sebastian Petzet, Darmstadt (DE)

(72) Inventors: Peter Cornel, Oberursel (DE); Sebastian Petzet, Darmstadt (DE)

(73) Assignee: TECHNISCHE UNIVERSITAT DARMSTADT, DARMSTADT (DE)

(21) Appl. No.: 13/700,513

(22) PCT Filed: Jun. 1, 2011
(86) PCT No.: PCT/EP11/59107

§ 371 Date: Feb. 5, 2013

(30) Foreign Application Priority Data
Jun. 1, 2010 (DE) 102010022381.6

(51) Int. Cl. C02F 11/00

(52) U.S. Cl. CPC C02F 11/00
USPC 252/182.29; 210/696

(57) ABSTRACT

The invention describes a method to prevent the formation of struvite in wastewater treatment plants. For that purpose, calcium silicate hydrate (CSH) is metered out into the excess sludge.

### DESCRIPTION OF, AND INTRODUCTION TO, THE GENERAL FIELD OF THE INVENTION

The present invention refers to an invention to reduce the formation of magnesium ammonium phosphate (MAP, struvite) in wastewater treatment plants. MAP accumulates as an undesired by-product in wastewater treatment plants. MAP forms incrustations which have to be removed; this is a time consuming process.

### STATE OF THE ART

The current wastewater treatment in wastewater treatment plants reduces the concentration of phosphorous in the wastewater and converts it into sludge. When treating and stabilizing this sludge, undesired MAP is frequently formed. This has to be removed, a process which is highly time-consuming.

### AIM

The aim of the present invention is to eliminate the disadvantages of the state of the art using a mixture of substances.

### Achievement of this Aim

This aim is achieved according to the present invention through the use of a mixture of substances which comprises calcium silicate hydrate (CSH) and sludge. This has the advantage that the phosphorous in the sludge water is suitable to be bonded to the CSH. This allows the sludge to be dehydrated more easily. Additionally, the addition of CSH readily increases the pH value. The binding of phosphorous and magnesium to the CSH considerably reduces or mostly prevents a precipitation of MAP in the tubes and containers. The MAP formed remains in the sludge and is therefore suitable to be easily removed.

The CSH comprises tobermorite (Ca₅[Si₃O₈(OH)]₂.2-5 H₂O), wollastonite, xonolite, hillebrandite, porylite, circolsil, sandy limestone or a combination of these substances. The CSH comprises 50% to 100%, and preferably 70%, tobermorite. The CSH comprises water from 0 to 40%. Water contents of approximately 30% are preferably used. CSH is used with a grain size from 0.1 to 10 mm. Alternatively, grain sizes from 0.001 to 10 mm are suitable to be used. Grain sizes from 0.1 to 0.5 or 4 mm are preferably used. Grain sizes from 0.1 to 0.5 mm are particularly used when the CSH has to remain in the sludge. In this case, grain sizes from 0.001 to 0.1 mm are suitable to be used. Grain sizes from 0.5 to 1 mm are especially used when the phosphorous-loaded CSH has to be separated again. An easier separation is suitable to be achieved using grain sizes in the range from 3 to 4 mm, as the pores of the sieve do not become clogged so easily. The CSH does not have to comprise a distinctive pore structure; however, this would be an advantage. CSH with a specific surface of approx. 40 mm³/g is preferably used.

Furthermore, fragments of aerated concrete (e.g. shaped bricks from Ytong comprise CSH) are used. The fragments are part of shaped bricks which form a correlation of several grain sizes. The fragments comprise CHS grain sizes from 2 to 10 mm. In comparison to dry CSH, CSH containing water is considerably more cost-effective.

Sludge comprises primary sludge, excess sludge, return sludge, raw sludge (a mixture of primary and excess sludge), activated sludge or combinations of these types of sludge, wherein this also comprises stabilized (anaerobic mesophilically/thermophilically and aerobic mesophilically/thermophilically stabilized types of sludge.

The dosage of the CSH preferably occurs in the excess sludge in the digestion tower. The excess sludge is hereby available in a concentration of 20 to 70 g/l, preferably 40 to 60 g/l. The CSH is applicable in all grain forms, e.g. ball-shaped, rectangular, angular or irregular.

Until now, it has been assumed that CSH is not suitable to form phosphorous in types of sludge with an organic concentration from 20 . . . 30 g/l, as these types of sludge are too highly viscous.

In the experiments, it was possible to show that CSH is suitable to bind phosphorous even in highly viscous types of sludge. In this way, phosphorous from excess types of sludge is particularly well bound to the CSH.

A separation of the CSH loaded with phosphorous is suitable to be carried out. The CSH is, however, preferably left in the sludge. The CSH loaded with phosphorous is further processed into fertilizer.

Due to the relevant reduction of the phosphorous concentration in the sludge water using CSH containing water, a reduction of the formation of the undesired MAP is suitable to be achieved. As a further advantage, the sludge was suitable to be dehydrated more quickly, and lower water concentrations were suitable to be achieved than without CSH.

The CSH is added to a type of sludge. The sludge is either flowing or stationary.

CSH should be added to the sludge before, during or after the stabilization of the sludge. CSH is preferably added in exact doses to the excess sludge or raw sludge (mixture of primary and excess sludge) with subsequent anaerobic stabilization. The use of CSH has the advantage that the phosphate binding also occurs in case of highly viscous sludge. Thus, it is also possible to add CSH to the sludge after stabilization.

The CSH is metered out in such a way that 0.05 g to 0.5 g CSH is used per gram of dry amount of sludge. Alternatively, 0.001 g to 1 g CSH is suitable to be metered out per gram of dry amount of sludge. However, this also depends on the sludge. In case of non-stabilized types of sludge, 0.001 to 0.1 g CSH is also suitable to be metered out per gram of dry amount of sludge. In case of stabilized types of sludge, 0.005 g to 0.5 g, preferably 0.024 g to 0.1 g, CSH is suitable to be used per gram of dry amount of sludge.

Alternatively, 0.1 g to 0.3 g CSH is used per gram of dry amount of sludge. 0.125 g CSH is also suitable to be used per gram of dry amount of sludge.

Importance is hereby attached to the fact that the pH value is not changed or is only changed within minor limits. An increase in the pH value of 0.4 is preferred. The dosage is adjusted in such a way that the change in pH value does not exceed 0.8. This is particularly important in case of dosage in the stabilizing reactor in order to not impair the biological degradation processes. The pH value is located in the range from 5 to 8.5. The pH value of the digestion tower is most frequently located between 6.8 and 7.3. This corresponds to a neutral medium. The method occurs in an acidic, neutral and alkaline medium. It is not limited to a certain pH range.

The dosage amount of the CSH also depends on the phosphate content of the sludge. By way of example, the excess sludge contains approx. 80% of the phosphate, whilst the phosphate pollution of the primary sludge is considerably lower.

The CSH in subsequently available in a ratio from 1:40 to 1:0.5 in comparison to the solid type of sludge. Alternatively, a ratio from 1:100 to 1:0.5 between CSH and solid type of sludge is suitable to be adjusted.

During or after having added CSH to the sludge, the sludge is mixed with the CSH.

The CSH remains in the sludge for approximately 5 to 20 days. This has the advantage that the phosphorus is suitable to be absorbed both on the surface and into the CSH material due to the long exposure time.

### EMBODIMENTS

Excess sludge is removed from the secondary sedimentation basin with a concentration of 8 g/l solid substance. CSH with a grain size from 0.1 to 0.5 is preferably dosed to the excess sludge. The latter is mixed with parts of the primary sludge and transferred for stabilization. The substance is then usually thickened to a solid of approx. 40 to 50 g/l. The thickened sludge mixture is then transferred for stabilization; after stabilization, there is usually 20 to 30 g/l of solid substance. In order to be able to take advantage of improved dehydration, the CSH should be dosed after stabilization at the latest.

A solid ratio from 1:40 to 1:0.5 of the CSH to the solid type of sludge should hereby be maintained. Alternatively, a ratio from 1:100 to 1:0.5 between CSH and solid type of sludge is suitable to be maintained.

The phosphate pollution of the sludge water was suitable to be reduced from approx. 220 mg/l to 25 mg/l.

Excess sludge is removed from the secondary sedimentation basin along with a concentration of 8 g/l of solid substance and thickened. The excess sludge is circulated via a bypass. The CSH is taken from a plaster silo and mixed in the bypass with part of the circulated excess sludge. The highly concentrated CSH solution is subsequently pumped into the digestion tower, where the concentrated solution is mixed with the remaining excess sludge. CSH with a grain size from 0.5 to 1 mm is preferably metered out to the excess sludge. Alternatively, fractions of aerated concrete shaped bricks are metered out. The latter is mixed with parts of the primary sludge and transferred for stabilization.

A solid ratio from 1:100 to 1:0.5 of the CSH to the solid type of sludge should hereby be maintained.

The phosphate pollution of the sludge water was suitable to be reduced from approx. 225 mg/l to 20 mg/l.

A recovery of the phosphorous-loaded CSH is possible via separation by means of a hydrocyclone or a sieve.

### FIGURES AND LIST OF REFERENCE NUMERALS

FIG. 1 Scheme of a waste treatment plant

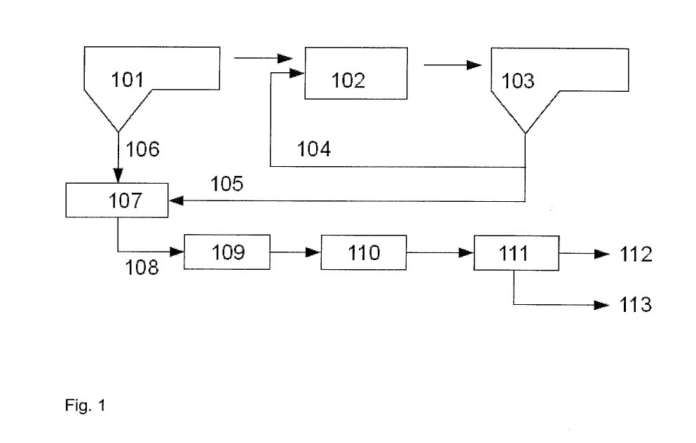

101: Primary sedimentation basin
102: Activated sludge tank
103: Secondary sedimentation basin
104: Return sludge
105: Excess sludge
106: Primary sludge
107: Mixing device for primary and excess sludge
108: Raw sludge (mixture primary and excess sludge)
109: Pre-thickener
110: Stabilizing reactor
111: Post-thickener
112: Sludge water
113: Sludge disposal

1. Method for the production of a mixture to reduce the formation of magnesium ammonium phosphate (MAP) in wastewater treatment plants, wherein the following steps occur:
Addition of calcium silicate hydrate (CSH) to stationary or flowing sludge using a dosage of calcium silicate hydrate (CSH) within a range from 0.001 g to 1 g per dry amount of sludge, so that the pH value in the sludge increases by a maximum of 0.8,
Mixing the CSH with the sludge.

2. Method according to claim 1, wherein the calcium silicate hydrate (CSH) comprises tobermorite, wollastonite, xonolite, hillebrandite, sandy limestone or a combination of these substances.

3. Method according to claim 1, wherein the calcium silicate hydrate (CSH) comprises 50% to 100% tobermorite, preferably 70% tobermorite.

4. Method according to claim 1, wherein the calcium silicate hydrate (CSH) comprises 0% to 40% water, preferably 30% water.

5. Method according to claim 1, wherein the calcium silicate hydrate (CSH) is used with a specific surface area of 40 m²/g.

6. Method according to claim 1, wherein the sludge comprises primary sludge, excess sludge, return sludge, raw sludge, activated sludge or a combination of these types of sludge, wherein stabilized types of sludge are also comprised.

7. Method according to claim 1, wherein the sludge is excess sludge and is removed in a secondary clarification tank before the addition of the calcium silicate hydrate (CSH) with a concentration of 8 g/l solid substance.

8. Method according to claim 7, wherein the excess sludge is mixed with parts of the primary sludge after the addition of the calcium silicate hydrate (CSH) and transferred to the stabilization.

9. A substance mixture to reduce the formation of magnesium ammonium phosphate (MAP) in wastewater treatment plants, wherein the mixture comprises sludge from one waste treatment plant and calcium silicate hydrate (CSH) in a ratio 100:1 to 0.5:1, wherein the ratio is referred to the dry amount of sludge.
